(19) United States
(12) Patent Application Publication
(10) Pub. No.: US 2015/0146054 A1
(43) Pub. Date: May 28, 2015

(54) IMAGE SENSORS WITH COLOR FILTER ELEMENTS OF DIFFERENT SIZES

(71) Applicant: Aptina Imaging Corporation, George Town (KY)

(72) Inventors: Brian Vaartstra, Nampa, ID (US); Mitchell J. Mooney, Star, ID (US); Stanley Micinski, Meridian, ID (US)

(73) Assignee: Aptina Imaging Corporation, George Town (KY)

(21) Appl. No.: 14/092,613

(22) Filed: Nov. 27, 2013

(51) Int. Cl. H04N 9/04

(52) U.S. Cl. CPC H04N 9/045
USPC 348/280; 348/273

(57) ABSTRACT

An image sensor may be provided with an array of imaging pixels. A color filter array may be formed over photosensitive elements in the pixel array. The color filter array may include color filter elements of different sizes. The color filter array may include color filter elements of at least three different sizes. The color filter array may include color filter elements of only two different sizes. Each color filter element by be square, octagonal, or rectangular. Microlenses of different sizes may also be formed on top of the color filter elements of different sizes. Forming color filter elements with different sizes may help skew the quantum efficiency for light at particular wavelengths of interest so that smaller pixel sizes can be used without suffering from diffraction limits.

### BACKGROUND

This relates generally to imaging devices, and more particularly, to imaging devices with color filter arrays.

Image sensors are commonly used in electronic devices such as cellular telephones, cameras, and computers to capture images. In a typical arrangement, an electronic device is provided with an array of image pixels arranged in pixel rows and pixel columns. Circuitry is commonly coupled to each pixel column for reading out image signals from the image pixels.

Conventional imaging systems employ a single image sensor in which the visible light spectrum is sampled by red, green, and blue (RGB) image pixels arranged in a Bayer mosaic pattern. A red pixel refers to an image sensor pixel that is covered by a red color filter element. A green pixel refers to an image sensor pixel that is covered by a green color filter element. A blue pixel refers to an image sensor pixel that is covered by a blue color filter element.

The Bayer Mosaic pattern consists of a repeating cell of two-by-two image pixels, with two green pixels diagonally opposite one another, and the other corners being red and blue.

Typically, the size of each image pixel and the size of the corresponding color filter elements are of the same size (i.e., the red color filter element has the same size as the green color filter element and the blue color filter element). As the size of pixels becomes smaller in each successive generation, the diffraction limit of red light may severely diminish the quantum efficiency of the red light. As a result, the regular Bayer pattern having color filter elements of the same size does not readily enable further miniaturization of image sensors via smaller image pixel sizes due to the diffraction limit of light in the longer visible wavelengths.

It would therefore be desirable to be able to provide imaging devices with improved means of capturing and processing image signals.

### BRIEF DESCRIPTION OF THE DRAWINGS

FIG. 1 is a diagram of an illustrative electronic device having an image sensor with a color filter array in accordance with an embodiment of the present invention.

FIG. 2 is a cross-sectional side view of a portion of a conventional pixel array.

FIG. 3 is a top view of a conventional color filter array having color filter elements of the same size.

FIG. 4 is a top view of an illustrative color filter array having color filter elements of different sizes in accordance with an embodiment.

FIG. 5 is a top view of an illustrative color filter array having color filter elements with cut corners in accordance with an embodiment.

FIG. 6 is a top view of an illustrative color filter array having microlenses of different sizes in accordance with an embodiment.

FIG. 7 is a top view of a color filter array housing structure having containers of different sizes in which color filter array elements may be formed in accordance with an embodiment.

FIG. 8 is a block diagram of a processor system employing the embodiments of FIGS. 4-7 in accordance with an embodiment.

### DETAILED DESCRIPTION

Electronic devices such as digital cameras, computers, cellular telephones, and other electronic devices include image sensors that gather incoming light to capture an image. The image sensors may include arrays of imaging pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the imaging pixels and readout circuitry for reading out image signals corresponding to the electric charge generated by the photosensitive elements.

Image sensors may be provided with color filter arrays having color filter elements arranged in a predetermined pattern. Image sensors having color filter arrays may be front-side illumination (FSI) image sensors or backside illumination (BSI) image sensors.

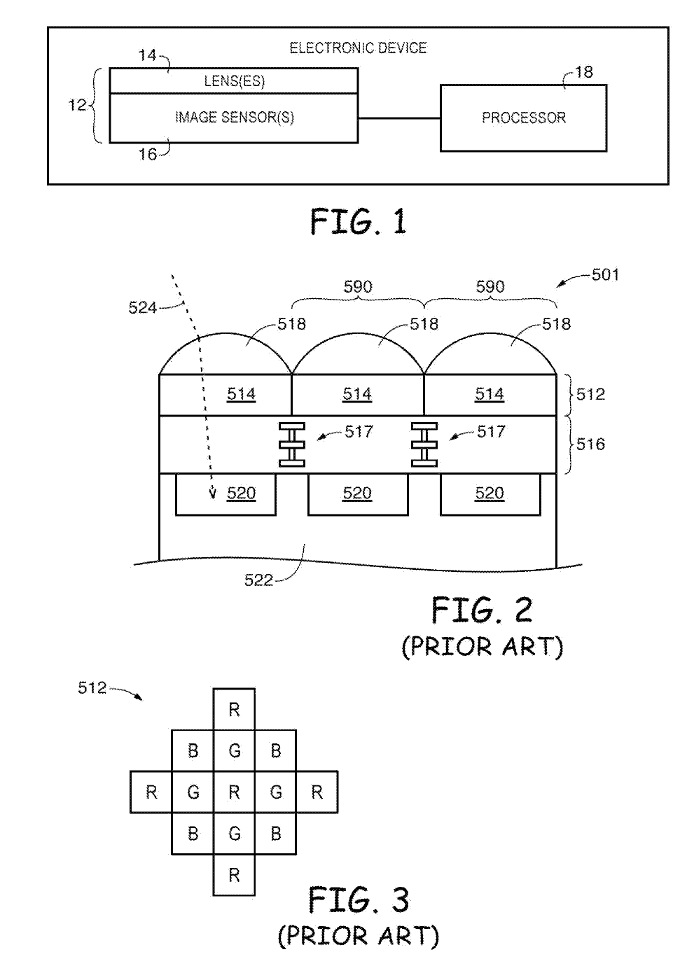

FIG. 1 is a diagram of an illustrative electronic device that uses an image sensor to capture images. Electronic device 10 of FIG. 1 may be a portable electronic device such as a camera, a cellular telephone, a video camera, or other imaging device that captures digital image data. Camera module 12 may be used to convert incoming light into digital image data. Camera module 12 may include one or more lenses 14 and one or more corresponding image sensors 16. During image capture operations, light from a scene may be focused onto image sensor 16 by lens 14. Image sensor 16 provides corresponding digital image data to processing circuitry 18. Image sensor 16 may, for example, be a backside illuminated image sensor. If desired, camera module 12 may be provided with an array of lenses 14 and an array of corresponding image sensors 16.

Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18. Processed image data may, if desired, be provided to external equipment (e.g., a computer or other device) using wired and/or wireless communications paths coupled to processing circuitry 18.

Image sensor 16 may include a pixel array containing image sensor pixels arranged in rows and columns. The image sensor pixels may be configured to gather image data to be used in generating images of a scene. The term “imaging pixel” may be used to describe a pixel that gathers color image data to be used in generating images of a real-world scene. Each imaging pixel may include an associated imaging pixel circuit. A filter such as color filter element may be formed over each imaging pixel in the array.

Image sensor 16 may also include control circuitry that can be used to supply control signals such as reset, transfer, and read control signals to the imaging pixels. Control circuitry may include sample-and-hold circuitry, amplifier circuitry, analog-to-digital conversion circuitry, bias circuitry such as pixel column bias supply circuits, memory, or other circuitry for operating the image pixels. Image data from the pixels having separated color filter elements may be gathered during pixel readout operations and may be subsequently used to generate an image of a real-world scene.

FIG. 2 shows a cross-sectional side view of a portion of a conventional pixel array 501 having pixels 590. Pixels 590 include microlens 518, color filter elements 514, dielectric layer 516, and photodiodes 520 formed in a substrate 522. Routing structures such as conductive interconnect routing structures 517 are formed in dielectric layer 516. Each microlens 518 directs incident light towards an associated photodiode 520. As shown in FIG. 2, incident light 524 is directed by microlens 518 towards photodiode 520. Photodiode 520 absorbs incident light focused by microlens 518 and produces image signals that correspond to the amount of incident light absorbed.

The color filter elements 514 collectively form a color filter array 512. In conventional image pixel arrays, color filter array 512 includes color filter elements 514 formed in a Bayer pattern (see, FIG. 3). As shown in FIG. 3, color filter array 512 includes red color filter elements (marked as “R”), green color filter elements (marked as “G”), and blue color filter elements (marked as “B”) arranged in a regular R-G-G-B pattern that is repeated across the entire color filter array 512. The red color filter elements (R) only pass through red light. The green color filter elements (G) only pass through green light. The blue color filter elements (B) only pass through blue light.

Typically, each color filter element in a conventional color filter array has the same size and shape (i.e., each of color filter elements R, G, and B are square and occupy the same area). As pixel size becomes smaller with each successive generation of imaging sensor devices, one problem that may arise is the diffraction limit of red light. Due to this diffraction limitation, the quantum efficiency may be significantly degraded for pixels that are smaller than 0.7 microns on one side (as an example). It may therefore be desirable to form color filter elements of varying sizes optimized for the wavelength(s) of interest.

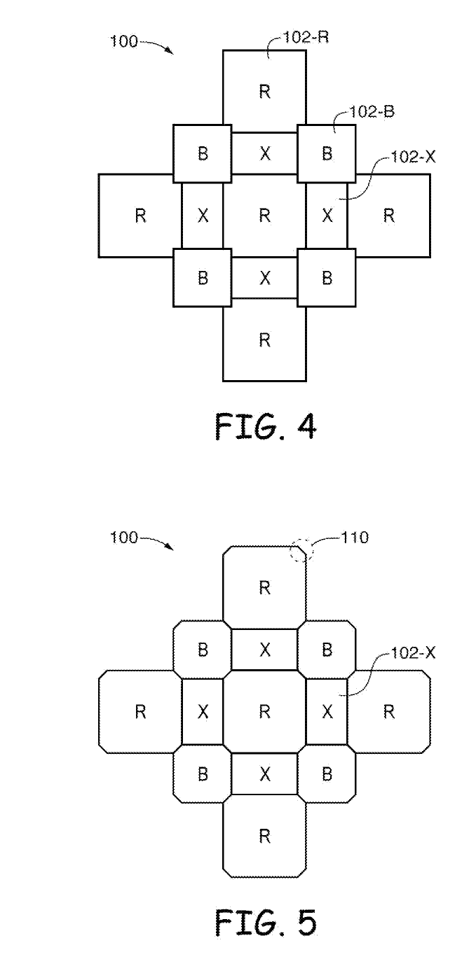

FIG. 4 shows one suitable arrangement in which a color filter array such as color filter array 100 having color filter elements of different sizes. As shown in FIG. 4, color filter array 100 may include red color filter elements 102-R of a first size, blue color filter elements 102-B of a second size, and another color filter element 102-X of a third size. Color filter element 102-X may be a yellow color filter element, a green color filter element, a cyan color filter element, a magenta color filter element, an infrared-pass filter element (e.g., a filter that passes infrared light), an IR-block filter element (e.g., a filter that blocks infrared light), a clear color filter element (e.g., a filter that passes all visible light), or any combination of color filter elements (e.g., in each unit cell, one X pixel containing a green color filter and the other containing an IR pass filter).

In the example of FIG. 4, the red color filter elements 102-R are bigger than the blue color filter elements 102-B, and the blue color filter elements 102-B are bigger than color filter elements 102-X. Sizing the color filter elements in this way can help improve the quantum efficiency (QE) of the red pixels (i.e., the image sensor pixels formed below the red color filter elements 102-R) and thereby reduce the attenuation of red light due to diffraction limits. In general, it may desirable to form red color filter elements to be bigger than color filter elements of other colors.

As shown in FIG. 4, the red color filter elements 102-R and the blue color filter elements 102-B may be square-shaped, whereas color filter elements 102-X may be rectangular. This is merely illustrative. If desired, any color filter element in color filter array 100 may be square, rectangular, octagonal, hexagonal, circular, etc. The sizing of the color filter elements may also be selected to optimize for the wavelength of interest. As an example, color filter array 100 may have blue color filter elements 102-B as the largest color filter element in scenarios where the quantum efficiency for blue light is critical. As another example, color filter array 100 may have yellow color filter elements 102-X as the largest color filter element in applications where the quantum efficiency for yellow light is critical. As yet another example, color filter array 100 may have yellow IR filter elements 102-X as the largest color filter element in applications where the quantum efficiency for infrared light is critical.

In general, image sensor pixels formed below each of the color filter elements in array 100 may be the same size or may be different sizes. In the scenario in which the image sensor pixels are of the same size (dimension), each image pixel may be formed directly below an associated color filter element of a given color and may partially overlap with at least one neighboring color filter element of a different color. In the scenario in which the image sensor pixels are of different sizes, each image pixel may be sized according to the size of the corresponding color filter element (e.g., image pixels formed below larger color filter elements may be bigger than neighboring pixels, whereas image pixels formed below smaller color filter elements may be smaller than neighboring pixels).

The color filter arrangement of FIG. 4 is merely illustrative and does not serve to limit the scope of the present invention. If desired, color filter array 100 may include color filter elements of at least two different sizes, of only two different sizes, of at least three different sizes, of more than three different sizes, etc.

FIG. 5 shows another suitable arrangement in which at least some color filter elements in array 100 have corners removed (see cut portion 110) to prevent potential overlapping of color filter elements. In the example of FIG. 5, the red and blue color filter elements have cut corners and are octagonal, whereas color filter elements 102-X have sharp corners and are rectangular (but not square-shaped).

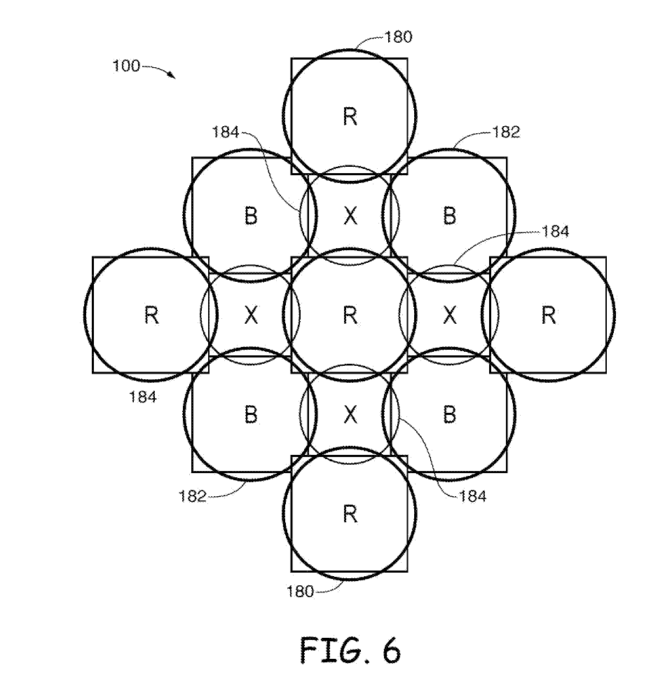

In another suitable arrangement, color filter array 100 may be formed using color filter elements of only two sizes (see, e.g., FIG. 6). As shown in FIG. 6, color filter array 100 may include over-sized red color filter elements (R), over-sized blue color filter elements (B) that have the same size as the red color filter elements, and color filter elements (X) that are smaller than the over-sized color filter elements. Over-sizing red and blue together in this way may provide improved red-to-green and blue-to-green color ratios at large apertures (particularly if additional blue QE is desired). Forming two over-sized color filter elements of the same size also allows all of the color filter elements in array 100 to be square-shaped.

Still referring to FIG. 6, microlenses of different sizes can also be formed over color filter array 100. For example, microlenses 180 may be formed over the red color filter elements; microlenses 182 may be formed over the blue color filter elements; and microlenses 184 may be formed over color filter elements (X). Microlenses 180 and 182 may be the same size and may be larger than microlenses 184 (e.g., the diameter of microlenses 180 and 182 may be greater than the diameter of microlens 184). In other words, the size of the microlenses may be adjusted to match the size of each respective color filter element in array 100 to optimize light collection at the over-sized image pixels (i.e., to optimize light collection for image sensor pixels formed below the over-sized color filter elements).

In general, microlenses of different sizes may be formed in at least two layers. As an example, the larger microlenses (i.e., microlenses 180 and 182) may be formed in a first layer, whereas the smaller microlenses (i.e., microlenses 184) may be formed in a second layer that is below the first layer. As another example, the larger microlenses (i.e., microlenses 180 and 182) may be formed in a first layer, whereas the smaller microlenses (i.e., microlenses 184) may be formed in a second layer that is above the first layer.

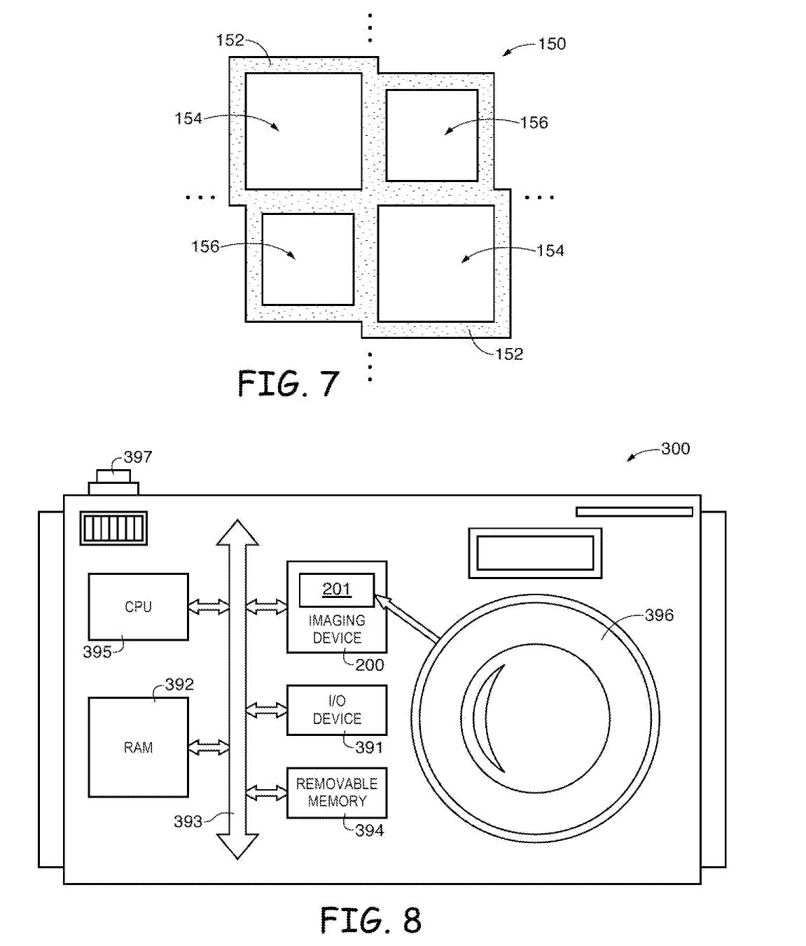

In some embodiments, each color filter element may be formed in a color filter element housing structure such as structure 150 (see, e.g., FIG. 7). Structure 150 may be formed using dielectric material and may include slots or holes that serve as containers for each color filter element. As shown in FIG. 7, structure 150 may have holes 154 in which over-sized color filter elements are inserted and may have holes 156 in which smaller color filter elements are inserted (e.g., holes 154 are larger than holes 156). An array of color filter elements that are contained within such types of housing structures are sometimes referred to as a CFA-in-a-box (abbreviated as “CIAB”). Structure 150 may serve to provide improved light guiding capabilities for directing light to the desired image sensor pixels.

Dielectric color filter element housing structure 150 of FIG. is merely illustrative and does not serve to limit the scope of the present invention. If desired, housing structure 150 may include holes of different sizes to contain color filter elements of any number of sizes (e.g., box 150 may include holes of at least two different sizes, holes of at least three different sizes, holes of at least four different sizes, etc.).

In yet other configurations, each color filter element in array 100 may be separated from neighboring color filter elements by a separating material having a relatively low index of refraction in comparison with the index of refraction of the color filter element. As an example, neighboring color filter elements may be separated by an air gap between the color filter elements. The change in the index of refraction between the color filter element and the separating material (e.g., the air) may have a light-piping effect that helps prevent light that has entered a particular color filter element from exiting that color filter element and reaching the photosensitive element of a neighboring pixel.

FIG. 8 shows in simplified form a processor system 300, such as a digital camera, which includes an imaging device 200. Imaging device 200 may include a pixel array 201 that are covered using a color filter array of the type described in connection with FIGS. 4-7. Processor system 300 is exemplary of a system having digital circuits that may include imaging device 200. Without being limiting, such a system may include a computer system, still or video camera system, scanner, machine vision, vehicle navigation, video phone, surveillance system, auto focus system, star tracker system, motion detection system, image stabilization system, and other systems employing an imaging device.

Processor system 300, which may be a digital still or video camera system, may include a lens such as lens 396 for focusing an image onto a pixel array such as pixel array 201 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating image sensors that have color filter arrays with color filter elements of different sizes. In particular, a color filter array (CFA) may include color filter elements of at least, two different sizes. In one arrangement, the color filter array may include color filter elements of only two different sizes. In another arrangement, the color filter array may include color filter elements of at least three different sizes.

For example, the color filter array may include a red color filter element, a blue color filter element, and another color filter element (e.g., a yellow color filter element, a green color filter element, a cyan color filter element, a magenta color filter element, an IR-pass filter element, an IR-block filter element, a clear color filter element, or other suitable types of color filter). In one scenario, the red color filter element may exhibit a first size; the blue color filter element may exhibit a second size that is smaller than the first size; and the another color filter element may exhibit a third size that is smaller than the second size. In another scenario, the red color filter element may exhibit a given size; the blue color filter element may exhibit the given size; and the another color filter element may exhibit a size that is smaller than the given size.

In some embodiments, at least some of the color filter elements may have cut corners. The color filter elements having removed corners may be octagonal. Color filter elements that are not octagonal may be rectangular. In other embodiments, some color filter elements may be square-shaped while others may be rectangular but not square-shaped.

The color filter elements may be formed in a dielectric color filter element housing structure. The housing structure may include holes of different sizes in which the different sized color filter elements can be inserted. For example, the dielectric housing structure may have larger holes for accommodating the over-sized color filter elements and may have smaller holes for accommodating the relatively smaller color filter elements in the color filter array. In general, microlenses may be formed over the color filter elements. Microlenses that are formed over bigger color filter elements may have diameters that are greater than those of microlenses formed over comparatively smaller color filter elements.

The foregoing is merely illustrative of the principles of this invention and various modifications can be made by those skilled in the art without departing from the scope and spirit of the invention. The foregoing embodiments may be implemented individually or in any combination.

What is claimed is:

1. An image sensor, comprising:
a plurality of image sensor pixels; and
a color filter array formed over the plurality of image sensor pixels, wherein the color filter array includes color filter elements of at least two different sizes.

2. The image sensor defined in claim 1, wherein the color filter array includes color filter elements of only two different sizes.

3. The image sensor defined in claim 1, wherein the color filter array includes color filter elements of at least three different sizes.

4. The image sensor defined in claim 1, wherein the color filter array includes a red color filter element of a first size, a blue color filter element of a second size that is smaller than the first size, and another color filter element of a third size that is smaller than the second size.

5. The image sensor defined in claim 1, wherein the color filter array includes a red color filter element of a first size, a blue color filter element of the first size, and another color filter element of a second size that is smaller than the first size.

6. The image sensor defined in claim 1, wherein the color filter array includes an infrared filter element of a first size and another color filter element of a second size that is smaller than the first size.

7. The image sensor defined in claim 1, wherein at least some of the color filter elements in the color filter array have cut corners.

8. The image sensor defined in claim 1, wherein a first portion of color filter elements in the color filter array are octagonal, and wherein a second portion of color filter elements in the color filter array are rectangular.

9. The image sensor defined in claim 1, wherein a first portion of color filter elements in the color filter array are square-shaped, and wherein a second portion of color filter elements in the color filter array are rectangular but not square-shaped.

10. The image sensor defined in claim 1, further comprising:
a plurality of microlenses formed over the color filter array, wherein the plurality of microlenses includes microlenses of at least two different sizes.

11. An image sensor, comprising:
a substrate;
a plurality of image sensor pixels formed in the substrate;
a dielectric housing structure formed over the plurality of image sensor pixels, wherein the dielectric housing structure includes a first hole of a first size and includes a second hole of a second size that is different than the first size;
a first color filter element formed in the first hole; and
a second color filter element formed in the second hole.

12. The image sensor defined in claim 11, wherein the dielectric housing structure further includes a third hole of a third size that is different than the first and second sizes, the image sensor further comprising:
a third color filter element formed in the third hole.

13. The image sensor defined in claim 11, wherein the first color filter element comprises a red color filter element, wherein the second color filter element comprises a different type of color filter element than the red color filter element, and wherein the first hole in which the red color filter element is formed is larger than the second hole.

14. The image sensor defined in claim 11, wherein the first color filter element comprises an infrared filter element, wherein the second color filter element comprises a different type of color filter element than the red color filter element, and wherein the first hole in which the infrared filter element is formed is larger than the second hole.

15. The image sensor defined in claim 11, further comprising:
a first microlens of a first diameter that is formed over the first color filter element;
a second microlens of a second diameter that is formed over the second color filter element, wherein the second diameter is different than the first diameter.

16. The image sensor defined in claim 11, wherein the plurality of image sensor pixels comprises at least three different types of image sensor pixels that receive three different types of light and that exhibit the same pixel dimension.

17. The image sensor defined in claim 11, wherein the plurality of image sensor pixels comprises at least two different image sensor pixels that receive two different types of light and that exhibit different pixel dimensions.

18. A system, comprising:
a central processing unit;
memory;
input-output circuitry; and
an imaging device that comprises:
an image pixel array; and
a color filter array formed over the image pixel array, wherein the color filter array includes color filter elements of at least two different sizes.

19. The system defined in claim 18, wherein at least some color filter elements in the color filter array have cut corners, and wherein the color filter elements in the color filter array that have cut corners are octagonal.

20. The system defined in claim 18, wherein the imaging device further comprises:
microlenses of at least two different diameters formed over the color filter array.

21. The system defined in claim 18, wherein the color filter array includes red color filter elements of a first size and blue color filter elements of a second size that is smaller than the first size.

22. The system defined in claim 18, wherein the color filter array includes red color filter elements of a given size and blue color filter elements of the given size.

23. The system defined in claim 18, wherein the color filter array includes infrared filter elements of a first size and other color filter element of a second size that is smaller than the first size.
